(19) United States
(12) Patent Application Publication
(10) Pub. No.: US 2023/0062195 A1
(43) Pub. Date: Mar. 2, 2023

(54) QUICK COUPLER FOR A THREE-POINT HITCH

(71) Applicant: CNH Industrial America LLC, New Holland, PA (US)

(72) Inventor: Thomas James Paulson, Fargo, ND (US)

(21) Appl. No.: 17/462,158

(22) Filed: Aug. 31, 2021

(51) Int. Cl. A01B 59/043

(52) U.S. Cl. CPC A01B 59/043

(57) ABSTRACT

A quick coupler for a three-point hitch includes a first main support having an implement-facing surface. The quick coupler includes a second main support having an implement-facing surface. The quick coupler also includes a cross-beam extending between the first main support and the second main support, in which the cross-beam has an implement-facing surface. The quick coupler includes a first rib extending along the implement-facing surface of the first main support and along the implement-facing surface of the cross-beam. A portion of an outer surface of the first rib is positioned inward from an outer surface of the first main support. Furthermore, the quick coupler includes a second rib extending along the implement-facing surface of the second main support and along the implement-facing surface of the cross-beam. A portion of an outer surface of the second rib is positioned inward from an outer surface of the second main support.

### BACKGROUND

The present disclosure relates generally to a quick coupler for a three-point hitch.

Certain work vehicles, such as tractors, include a three-point hitch configured to engage a corresponding hitch of a towed implement. Certain three-point hitches include two lower lift arms and an upper link. Each lower lift arm includes an opening configured to receive a corresponding lower hitch pin of the towed implement hitch, and the upper link includes an opening configured to receive a corresponding upper hitch pin of the towed implement hitch. Each hitch pin may be disposed within a corresponding opening to couple the towed implement to the work vehicle.

To reduce the duration associated with coupling the work vehicle to the towed implement, a quick coupler may be coupled to the three-point hitch. The quick coupler may include lower hitch pins and an upper hitch pin, and each hitch pin may be disposed within a corresponding opening in the three-point hitch to couple the quick coupler to the three-point hitch. In addition, the quick coupler includes two lower hooks and an upper/anti-rotation hook. The lower hooks are configured to engage the lower hitch pins of the towed implement hitch, and the upper/anti-rotation hook is configured to engage the upper hitch pin of the towed implement hitch. For example, once the quick coupler is coupled to the three-point hitch, each hook may be aligned with a corresponding hitch pin of the towed implement hitch. The quick coupler may then be raised by the three-point hitch such that each hook engages the corresponding hitch pin. In addition, one or more locking mechanisms may be engaged to secure one or more hitch pins with the respective hooks. Accordingly, the duration associated with coupling the work vehicle to the towed implement may be significantly reduced (e.g., as compared to engaging each hitch pin of the towed implement hitch with a corresponding opening of the three-point hitch), and the duration associated with switching between different towed implements may also be significantly reduced. Due to the significant forces applied to the quick coupler during operation of the work vehicle/towed implement, the quick coupler may be formed from a large quantity of material (e.g., steel). Accordingly, the cost of the quick coupler may be significant due to the large amount of material used for its construction.

### BRIEF DESCRIPTION

In certain embodiments, a quick coupler for a three-point hitch includes a first main support having an implement-facing surface. The quick coupler also includes a first lower hook extending from the first main support. Furthermore, the quick coupler includes a second main support having an implement-facing surface. The quick coupler also includes a second lower hook extending from the second main support. In addition, the quick coupler includes a cross-beam extending between the first main support and the second main support. The cross-beam has an implement-facing surface, and the cross-beam is configured to support an anti-rotation hook. The quick coupler also includes a first rib extending along the implement-facing surface of the first main support and along the implement-facing surface of the cross-beam. A portion of an outer surface of the first rib is positioned inward from an outer surface of the first main support along the implement-facing surface of the first main support. Furthermore, the quick coupler includes a second rib extending along the implement-facing surface of the second main support and along the implement-facing surface of the cross-beam. A portion of an outer surface of the second rib is positioned inward from an outer surface of the second main support along the implement-facing surface of the second main support.

### DRAWINGS

These and other features, aspects, and advantages of the present disclosure will become better understood when the following detailed description is read with reference to the accompanying drawings in which like characters represent like parts throughout the drawings, wherein:

FIG. 1 is a side view of an embodiment of a work vehicle coupled to an implement via a three-point hitch;

FIG. 2 is a front perspective view of an embodiment of a quick coupler coupled to the three-point hitch of FIG. 1;

FIG. 3 is a front perspective view of the quick coupler of FIG. 2;

FIG. 4 is a front view of the quick coupler of FIG. 2;

FIG. 5 is a rear view of the quick coupler of FIG. 2; and

FIG. 6 is a cross-sectional view of the quick coupler of FIG. 2.

### DETAILED DESCRIPTION

One or more specific embodiments of the present disclosure will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” “the,” and “said” are intended to mean that there are one or more of the elements. The terms “comprising,” “including,” and “having” are intended to be inclusive and mean that there may be additional elements other than the listed elements. Any examples of operating parameters and/or environmental conditions are not exclusive of other parameters/conditions of the disclosed embodiments.

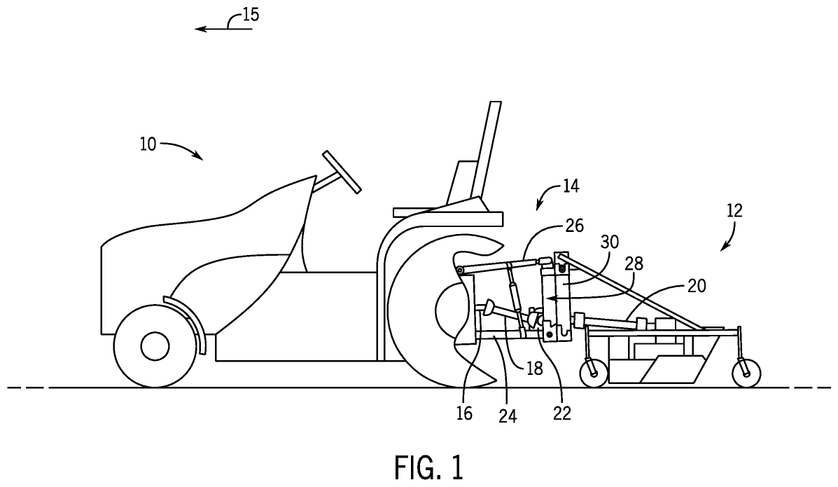

FIG. 1 is a side view of an embodiment of a work vehicle 10 coupled to an implement 12 via a three-point hitch 14. The work vehicle 10 is configured to tow the implement 12 (e.g., through a field) along a direction of travel 15. In the illustrated embodiment, the work vehicle 10 is a tractor. However, in other embodiments, the work vehicle may be any other suitable type of work vehicle configured to tow an implement, such as a harvester or a sprayer. Furthermore, in the illustrated embodiment, the implement 12 is a powered implement, such as a spreader, a rotary mower, or a rotary tiller. The implement is powered by a power-take off (PTO) shaft 16 of the work vehicle 10. An engine of the work vehicle 10 drives the PTO shaft to rotate (e.g., via a transmission, a PTO drive system, etc.), and rotation of the PTO shaft drives rotation of one or more rotary components of the implement 12, such as a rotary spreader system, mower blades, or a rotary tillage assembly. In the illustrated embodiment, the PTO shaft 16 includes a telescoping portion 18 configured to facilitate adjustment of a length of the PTO shaft 16 to accommodate different types of powered implements. However, in other embodiments, the work vehicle may have a non-telescoping PTO shaft. As illustrated, the PTO shaft 16 of the work vehicle 10 is coupled to a corresponding shaft 20 of the implement 12, and the corresponding shaft 20 of the implement 12 is configured to drive rotation of the rotary component(s) of the implement 12. The PTO shaft 16 and the corresponding shaft 20 of the implement 12 are coupled to one another via a connection assembly 22. The connection assembly 22 may include any suitable device(s) configured to couple the PTO shaft 16 to the corresponding shaft 20, such that rotation of the PTO shaft 16 drives the corresponding shaft 20 to rotate. While the implement 12 is a powered implement in the illustrated embodiment, in other embodiments, the implement may be a non-powered implement, such as a vertical tillage implement, a primary tillage implement, a seeding implement, or a finishing implement. In such embodiments, the PTO shaft of the work vehicle may not be coupled to a corresponding shaft of the implement, or the work vehicle may not include a PTO shaft.

In the illustrated embodiment, the implement 12 is coupled to the work vehicle 10 via the three-point hitch 14 of the work vehicle 10. As discussed in detail below, the three-point hitch 14 includes two lower lift arms 24 and an upper link 26. The two lower lift arms 24 and the upper link 26 are coupled (e.g., rotatably coupled) to a chassis of the work vehicle 10. In certain embodiments, an actuator is coupled to the lower lift arms and configured to drive the lower lift arms to rotate relative to the chassis of the work vehicle. Each lower lift arm 24 includes an opening configured to receive a corresponding lower hitch pin of the implement 12, and the upper link 26 includes an opening configured to receive a corresponding upper hitch pin of the implement 12. In certain embodiments, each hitch pin of the implement 12 may be disposed within a corresponding opening to couple the implement 12 to the work vehicle 10. Unfortunately, the process of coupling the hitch pins to the lower lift arms and the upper link may be time consuming, thereby increasing the duration associated with agricultural operations.

In the illustrated embodiment, a quick coupler 28 is coupled to the three-point hitch 14 to reduce the duration associated with coupling the work vehicle 10 to the implement 12. As discussed in detail below, the quick coupler 28 includes openings configured to receive two lower hitch pins and an upper hitch pin. Each hitch pin is configured to be disposed within a corresponding opening in the three-point hitch. Accordingly, the hitch pins couple the quick coupler to the three-point hitch. In addition, the quick coupler 28 includes two lower hooks and an upper/anti-rotation hook. The lower hooks are configured to engage the lower hitch pins of the implement 12 (e.g., which are coupled to a hitch frame 30 of the implement 12), and the upper/anti-rotation hook is configured to engage the upper hitch pin of the implement 12 (e.g., which is coupled to the hitch frame 30 of the implement 12). For example, once the quick coupler 28 is coupled to the three-point hitch 14, each hook may be aligned with a corresponding hitch pin of the implement 12. The quick coupler 28 may then be raised by the three-point hitch (e.g., via the actuator coupled to the lower lift arms 24), such that each hook engages the corresponding hitch pin of the implement 12. As a result, the implement 12 (e.g., the hitch frame 30 of the implement 12) is coupled to the quick coupler 28, thereby coupling the implement 12 to the three-point hitch 14 of the work vehicle 10. Accordingly, the duration associated with coupling the work vehicle 10 to the implement 12 may be significantly reduced (e.g., as compared to engaging each hitch pin of the implement with a corresponding opening of the three-point hitch), and the duration associated with switching between different implements may also be significantly reduced.

In certain embodiments, the quick coupler 28 includes a first main support having an implement-facing surface, and the quick coupler 28 includes a first lower hook extending from the first main support. In addition, the quick coupler 28 includes a second main support having an implement-facing surface, and the quick coupler 28 includes a second lower hook extending from the second main support. The quick coupler 28 also includes a cross-beam extending between the first main support and the second main support. The cross-beam has an implement-facing surface, and the cross-beam is configured to support an anti-rotation hook. Furthermore, the quick coupler 28 includes a first rib extending along the implement-facing surface of the first main support and along the implement-facing surface of the cross-beam. A portion of an outer surface of the first rib is positioned inward from an outer surface of the first main support along the implement-facing surface of the first main support. In addition, the quick coupler 28 includes a second rib extending along the implement-facing surface of the second main support and along the implement-facing surface of the cross-beam. A portion of an outer surface of the second rib is positioned inward from an outer surface of the second main support along the implement-facing surface of the second main support Because the quick coupler 28 includes the first and second ribs, the amount of material used in the construction of the quick coupler may be substantially reduced (e.g., as compared to a quick coupler formed without the ribs disclosed herein and configured to support an equal load), thereby significantly reducing the cost of the quick coupler.

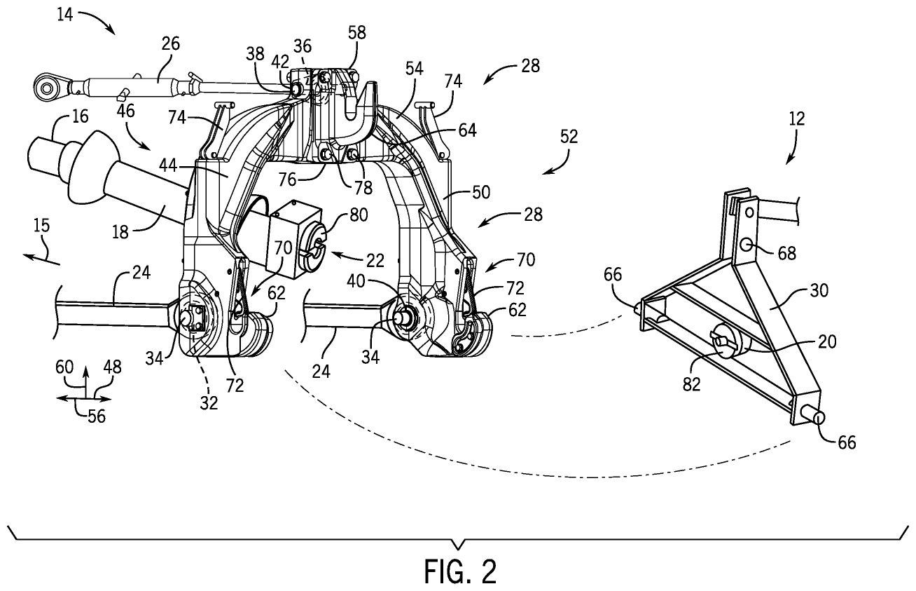

FIG. 2 is a front perspective view of an embodiment of a quick coupler 28 coupled to the three-point hitch 14 of FIG. 1. In the illustrated embodiment, each lower lift arm 24 has an opening 32 configured to receive a respective lower hitch pin 34, and the upper link 26 has an opening 36 configured to receive a respective upper hitch pin 38. In addition, the quick coupler 28 includes two lower openings 40 configured to receive the lower hitch pins 34 and an upper opening 42 configured to receive the upper hitch pin 38. The hitch pins are configured to be disposed through the openings in the three-point hitch and the quick coupler to couple the quick coupler 28 to the three-point hitch 14. In certain embodiments, each hitch pin may include an aperture on each longitudinal side of the hitch pin, and a cotter pin may be disposed through each aperture to secure the hitch pin to the three-point hitch and the quick coupler. However, in other embodiments, another suitable connection system may be used to couple the hitch pins to the three-point hitch and the quick coupler (e.g., at least one end of at least one hitch pin may include threads configured to receive a fastener, etc.).

In the illustrated embodiment, the quick coupler 28 includes a first main support 44 positioned on a first lateral side 46 of the quick coupler 28 (e.g., a first side along a lateral axis 48). In addition, the quick coupler 28 includes a second main support 50 positioned on a second lateral side 52 of the quick coupler 28 (e.g., a second side along the lateral axis 48), in which the second lateral side 52 is opposite the first lateral side 46. In addition, the quick coupler 28 includes a cross-beam 54 extending between the first main support 44 and the second main support 50 along the lateral axis 48. As illustrated, the lateral axis 48 is perpendicular to a longitudinal axis 56, which may extend along (e.g., substantially along) the direction of travel 15. In addition, each lower opening 40 is formed within a respective main support, and the upper opening 42 is formed within a support 58 extending from the cross-beam 54. As illustrated, the upper opening 42 is positioned above the lower openings 40 along a vertical axis 60.

In the illustrated embodiment, the quick coupler 28 includes two lower hooks 62 and an upper (e.g., anti-rotation) hook 64. As illustrated, a first lower hook 62 extends from the first main support 44, and a second lower hook 62 extends from the second main support 50. Each lower hook 62 is configured to engage a corresponding lower hitch pin 66 of the implement 12. As illustrated, the lower hitch pins 66 extend laterally outward from opposite lateral sides of the hitch frame 30 of the implement 12. Furthermore, the upper/anti-rotation hook 64 is configured to engage a corresponding upper hitch pin 68 of the implement 12. As illustrated, the upper hitch pin 68 is positioned at a top portion of the hitch frame 30 of the implement 12. As previously discussed, once the quick coupler 28 is coupled to the three-point hitch 14, each hook may be aligned with a corresponding hitch pin of the implement 12. The quick coupler 28 may then be raised by the three-point hitch (e.g., via the actuator coupled to the lower lift arms 24), such that each hook engages the corresponding hitch pin of the implement 12. As a result, the hitch frame 30 of the implement 12 is coupled to the quick coupler 28, thereby coupling the implement 12 to the three-point hitch 14 of the work vehicle 10. Accordingly, the duration associated with coupling the work vehicle 10 to the implement 12 may be significantly reduced (e.g., as compared to engaging each hitch pin of the implement with a corresponding opening of the three-point hitch), and the duration associated with switching between different implements may also be significantly reduced.

In the illustrated embodiment, each main support includes a respective locking mechanism 70. Each locking mechanism 70 includes a moveable locking plate 72 configured to selectively block removal of the respective lower hitch pin 66 of the implement 12 while the lower hitch pin 66 is engaged with the respective lower hook 62. For example, after each lower hitch pin 66 is engaged with the respective lower hook 62, the respective locking mechanism 70 may be engaged to block removal of the lower hitch pin from the lower hook. In addition, to remove each lower hitch pin from the respective lower hook, the respective locking mechanism 70 may be disengaged. In the illustrated embodiment, the engagement and disengagement of each locking mechanism 70 is controlled by a respective lever 74 coupled to the respective main support.

Furthermore, in the illustrated embodiment, the upper/anti-rotation hook 64 is removably coupled to the cross-beam 54 and the support 58. A mount 76 is coupled to (e.g., integrally formed with) the upper/anti-rotation hook 64, and the mount 76 is removably coupled to the cross-beam 54 and the support 58 by fasteners 78. While the mount 76 is coupled to the cross-beam 54/support 58 by four fasteners 78 in the illustrated embodiment, in other embodiments, the mount may be coupled to the cross-beam 54/support 58 by more or fewer fasteners (e.g., 1, 2, 3, 5, 6, or more). Furthermore, while the mount 76 is coupled to the cross-beam 54/support 58 by fasteners in the illustrated embodiment, in other embodiments, the mount may be coupled to the cross-beam/support by other suitable type(s) of connection(s) (e.g., alone or in combination with the fasteners), such as clamp(s), a welded connection, an adhesive connection, other suitable type(s) of connection(s), or a combination thereof. In addition, in certain embodiments, the upper/anti-rotation hook may be non-removably coupled to (e.g., integrally formed with) the cross-beam. Furthermore, in certain embodiments, the upper/anti-rotation hook may be coupled to the cross-beam by a connection assembly that enables a vertical position of the upper/anti-rotation hook to be adjusted (e.g., including a series of apertures formed within the cross-beam/support and configured to receive the fasteners, including a sliding mechanism, etc.).

As previously discussed, the PTO shaft 16 is coupled to the corresponding shaft 20 of the implement 12 via the connection assembly 22. The connection assembly 22 includes a first connector 80 coupled to the PTO shaft 16 and a second connector 82 coupled to the corresponding shaft 20 of the implement 12. In the illustrated embodiment, the first connector 80 includes a recess configured to receive a protrusion of the second connector 82, thereby rotatably coupling the shafts to one another. However, in other embodiments, the first connector may include a protrusion and the second connector may include a recess configured to receive the protrusion to rotatably couple the shafts to one another. Furthermore, in other embodiments, the connection assembly may include any other suitable device(s)/element(s) configured to selectively couple the PTO shaft to the corresponding implement shaft. As previously discussed, coupling the PTO shaft to the corresponding implement shaft enables the PTO shaft to drive rotation of one or more rotary components of the implement.

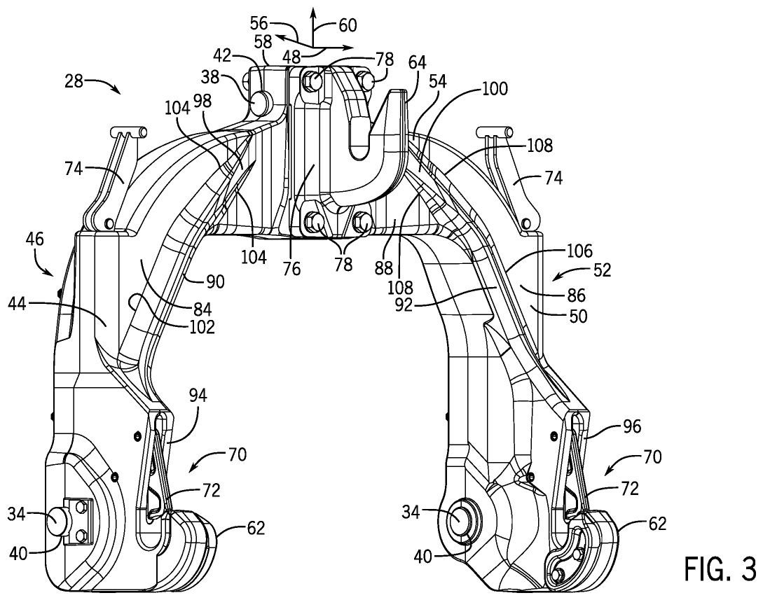

FIG. 3 is a front perspective view of the quick coupler 28 of FIG. 2. As illustrated, the first main support 44 has an implement-facing surface 84 (e.g., surface that faces the implement while the implement is coupled to the quick coupler 28), and the second main support 50 has an implement-facing surface 86 (e.g., surface that faces the implement while the implement is coupled to the quick coupler 28). Furthermore, the cross-beam 54 has an implement-facing surface 88 (e.g., surface that faces the implement while the implement is coupled to the quick coupler 28), and as previously discussed, the cross-beam 54 is configured to support the upper/anti-rotation hook 64. In addition, as previously discussed, the first lower hook 62 extends from the first main support 44, and the second lower hook 62 extends from the second main support 50.

In the illustrated embodiment, the quick coupler 28 includes a first rib 90 extending along the implement-facing surface 84 of the first main support 44 and along the implement-facing surface 88 of the cross-beam 54. In addition, the quick coupler 28 includes a second rib 92 extending along the implement-facing surface 86 of the second main support 50 and along the implement-facing surface 88 of the cross-beam 54. The ribs are configured to direct the stress applied to the lower hooks 62 through the structure of the quick coupler 28 (e.g., the main supports and the cross-beam), thereby reducing the maximum stress within the quick coupler 28. For example, the lower lift arms of the three-point hitch, which are coupled to the quick coupler 28 by the lower hitch pins 34, may be angled toward one another in the direction of the work vehicle chassis. Accordingly, as the work vehicle tows the agricultural implement through a field, the lower lift arms may apply a significant compressive force to the main supports, thereby urging the main supports toward one another along the lateral axis 48. As a result, a significant bending stress may be induced within each main support (e.g., establishing a hoop stress extending along the main supports and the cross-beam). The ribs collectively form a generally arcuate shape that directs the stress toward the lateral center of the cross-beam 54/support 58, thereby substantially reducing the stress within the main supports. As a result, the maximum stress within the quick coupler may be substantially reduced. Accordingly, the amount of material used in the construction of the quick coupler 28 may be substantially reduced (e.g., as compared to a quick coupler formed without the ribs disclosed herein and configured to support an equal load), thereby significantly reducing the cost of the quick coupler.

As previously discussed, each main support includes a respective locking mechanism 70, and each locking mechanism 70 includes a movable locking plate 72 configured to selectively block removal of the respective lower hitch pin of the implement. For example, the first lower hook 62 and the first locking plate 72 are configured to capture the first lower hitch pin of the implement, and the second lower hook 62 and the second locking plate 72 are configured to capture the second lower hitch pin of the implement. In the illustrated embodiment, the first main support 44 has a first locking plate support 94 configured to support the first locking plate 72, and the second main support 50 has a second locking plate support 96 configured to support the second locking plate 72. As illustrated, the first rib 90 extends from the first locking plate support 94 to the cross-beam 54, along the implement-facing surface 84 of the first main support 44, and along the implement-facing surface 88 of the cross-beam 54, and the second rib 92 extends from the second locking plate support 96 to the cross-beam 54, along the implement-facing surface 86 of the second main support 50, and along the implement-facing surface 88 of the cross-beam 54. Due to the significant amount of material within each locking plate support, the locking plate support resists bending and facilitates flow of the stress (e.g., bending stress, hoop stress, etc.) to the respective rib. As previously discussed, each rib directs the stress toward the lateral center of the cross-beam/support, thereby substantially reducing the stress within the respective main support. As a result, the maximum stress within the quick coupler (e.g., which may occur at an upper end of each locking plate support) may be substantially reduced. While each rib extends from a respective locking plate support in the illustrated embodiment, in other embodiments, at least one rib may extend from another suitable portion of the respective main support.

In the illustrated embodiment, the first rib 90 has a tapered section 98 extending along the implement-facing surface 88 of the cross-beam 54, and the second rib 92 has a tapered section 100 extending along the implement-facing surface 88 of the cross-beam 54. As illustrated, a height of the first rib 90 (e.g., extent of the first rib 90 from the implement-facing surface 88 of the cross-beam 54 along the longitudinal axis 56) decreases within the tapered section 98, and a height of the second rib 92 (e.g., extent of the second rib 92 from the implement-facing surface 88 of the cross-beam 54 along the longitudinal axis 56) decreases within the tapered section 100. In the illustrated embodiment, within each tapered section, the height of the respective rib decreases along a direction toward the lateral center of the cross-beam/support. The tapered sections are configured to facilitate the transfer of stress (e.g., bending stress, hoop stress, etc.) from the main supports to the lateral center of the cross-beam/support. While the height of each rib decreases within the tapered section along the direction toward the lateral center of the cross-beam/support in the illustrated embodiment, in other embodiments, the height of at least one rib may increase within the tapered section along the direction toward the lateral center of the cross-beam/support. Furthermore, while each rib includes a tapered section extending along the implement-facing surface of the cross-beam in the illustrated embodiment, in other embodiments, at least one rib may include a tapered section extending along the implement-facing surface of the respective main support (e.g., alone or in combination with the tapered section extending along the implement-facing surface of the cross-beam). For example, at least one rib may include a tapered section in which the height of the tapered section increases or decreases along a direction toward the respective locking plate support. In addition, while each rib includes a single tapered section at an end of the rib in the illustrated embodiment, in other embodiments, at least one rib may include more or fewer tapered sections (e.g., 0, 2, 3, 4, or more), and each tapered section may be located in any suitable position along the rib. For example, in certain embodiments, at least one rib may not have a tapered section.

In the illustrated embodiment, the first rib 90 is filleted at a first interface 102 between the first rib 90 and the implement-facing surface 84 of the first main support 44, and the first rib 90 is filleted at second interfaces 104 between the first rib 90 and the implement-facing surface 88 of the cross-beam 54. Furthermore, in the illustrated embodiment, the second rib 92 is filleted at a third interface 106 between the second rib 92 and the implement-facing surface 86 of the second main support 50, and the second rib 92 is filleted at fourth interfaces 108 between the second rib 92 and the implement-facing surface 88 of the cross-beam 54. Each fillet substantially reduces the possibility of forming a stress concentration at the respective interface, thereby facilitating the transfer of stress from the main supports to the lateral center of the cross-beam/support. While each rib is filleted at each rib/implement-facing surface interface in the illustrated embodiment, in other embodiments, at least one rib may have another suitable shape (e.g., chamfered, etc.) at a rib/implement-facing surface interface.

In certain embodiments, a portion of the quick coupler 28 (e.g., including the first main support 44, the first lower hook 62, the second main support 50, the second lower hook 62, the cross-beam 54, the first rib 90, and the second rib 92) may be formed via a casting process. For example, molten metal (e.g., steel, iron, etc.) may be poured into a mold cavity having the shape of the portion of the quick coupler. After the metal cools and hardens, the portion of the quick coupler may be removed from the mold cavity and the opening/apertures may be formed (e.g., drilled, etc.) in the portion of the quick coupler. Accordingly, a substantial portion of the quick coupler (e.g., including the first main support 44, the first lower hook 62, the second main support 50, the second lower hook 62, the cross-beam 54, the first rib 90, and the second rib 92) may be formed as a single cast element, thereby reducing the manufacturing cost of the quick coupler (e.g., as compared to a quick coupler having a substantial portion formed by a machining process). In certain embodiments, the portion of the quick coupler 28 may be formed from ductile iron via the casting process disclosed above. For example, the portion of the quick coupler may be formed from grade C or grade D ductile iron. The portion of the quick coupler 28 formed by the casting process may include any suitable elements of the quick coupler, such as any combination of the first main support 44, the first lower hook 62, the second main support 50, the second lower hook 62, the cross-beam 54, the first rib 90, and the second rib 92. For example, in certain embodiments, the portion of the quick coupler 28 may include the first main support 44, the second main support 50, the first rib 90, and the second rib 92.

Furthermore, in certain embodiments, a portion of the quick coupler 28 (e.g., including the first main support 44, the first lower hook 62, the second main support 50, the second lower hook 62, the cross-beam 54, the first rib 90, and the second rib 92) may be formed via an additive manufacturing process (e.g., three-dimensional printing, etc.) or a reductive manufacturing process (e.g., machining, etc.). Accordingly, a substantial portion of the quick coupler (e.g., including the first main support 44, the first lower hook 62, the second main support 50, the second lower hook 62, the cross-beam 54, the first rib 90, and the second rib 92) may be formed as a single additively manufactured/reductively manufactured element. The portion of the quick coupler 28 formed by the additive/reductive manufacturing process may include any suitable elements of the quick coupler, such as any combination of the first main support 44, the first lower hook 62, the second main support 50, the second lower hook 62, the cross-beam 54, the first rib 90, and the second rib 92. For example, in certain embodiments, the portion of the quick coupler 28 may include the first main support 44, the second main support 50, the first rib 90, and the second rib 92. In certain embodiments, the quick coupler may be formed by any combination of a casting process, an additive manufacturing process, a reductive manufacturing process, a coupling process, and other suitable process(es).

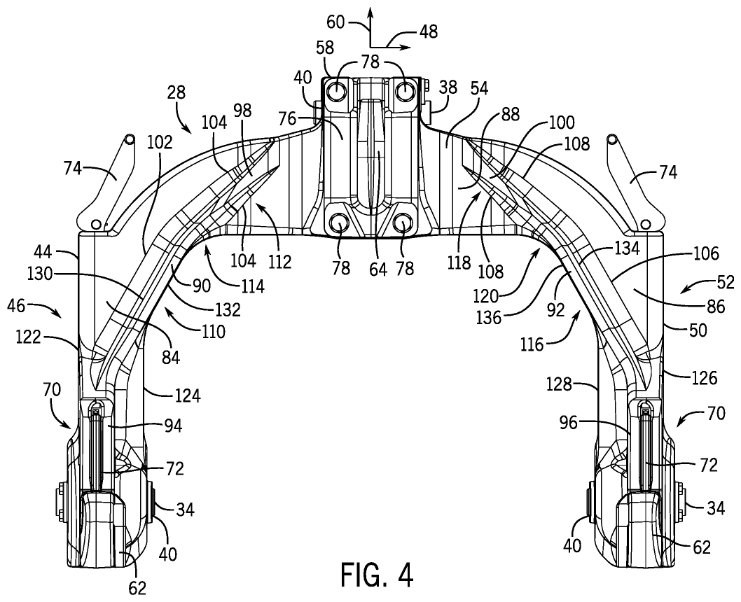

FIG. 4 is a front view of the quick coupler 28 of FIG. 2. In the illustrated embodiment, the first rib 90 has a first substantially straight portion 110, a second substantially straight portion 112, and a curved portion 114 positioned between the first and second substantially straight portions of the first rib 90. In addition, the second rib 92 has a first substantially straight portion 116, a second substantially straight portion 118, and a curved portion 120 positioned between the first and second substantially straight portions of the second rib 92. As illustrated, the first substantially straight portion of each rib extends generally along the implement-facing surface of the respective main support, the second substantially straight portion of each rib extends generally along the implement-facing surface of the cross-beam, and the curved portion of each rib is positioned generally at the transition between the respective main support and the cross-beam. As previously discussed, the shape of the ribs is configured to direct the stress (e.g., bending stress, hoop stress, etc.) toward the lateral center of the cross-beam/support, thereby substantially reducing the stress within the main supports. As a result, the maximum stress within the quick coupler may be substantially reduced. While each rib includes two substantially straight portions and a curved portion in the illustrated embodiment, in other embodiments, at least one rib may include more or fewer substantially straight portions (e.g., 0, 1, 3, 4, 5, 6, or more) and/or more or fewer curved portions (e.g., 0, 2, 3, 4, 5, 6, or more). For example, in certain embodiments, at least one rib may include a single portion that curves in an arcuate path along the implement-facing surface of the respective main support and the implement-facing surface of the cross-beam. Furthermore, in certain embodiments, at least one rib may include a single portion that extends in a substantially straight path along the implement-facing surface of the respective main support and the implement-facing surface of the cross-beam. In addition, in certain embodiments, at least one rib may include other portion(s) (e.g., alone or in combination with the straight portion(s) and/or the curved portion(s)), such as wavy portion(s), portion(s) that follow tortuous path(s), other suitable portion(s), or a combination thereof.

In the illustrated embodiment, the first rib 90 is symmetrical with the second rib 92 about the vertical axis 60 of the quick coupler 28. Accordingly, the first rib 90 is a mirror image of the second rib 92 with respect to the vertical axis 60. While the first rib is symmetrical with the second rib about the vertical axis in the illustrated embodiment, in other embodiments, the first and second ribs may have different shapes, such that the first and second ribs are not symmetrical about the vertical axis.

As illustrated, the first main support 44 has an outer surface 122 and an inner surface 124, and the second main support 50 has an outer surface 126 and an inner surface 128. In addition, the first rib 90 has an outer surface 130 and an inner surface 132, and the second rib 92 has an outer surface 134 and an inner surface 136. In the illustrated embodiment, a portion of the outer surface 130 of the first rib 90 (e.g., the outer surface 130 of the section of the first rib 90 extending along the implement-facing surface 84 of the first main support 44) is positioned inward (e.g., laterally inward) from the outer surface 122 of the first main support 44 along the implement-facing surface 84 of the first main support 44, and a portion of the outer surface 134 of the second rib 92 (e.g., the outer surface 134 of the section of the second rib 92 extending along the implement-facing surface 86 of the second main support 50) is positioned inward (e.g., laterally inward) from the outer surface 126 of the second main support 50 along the implement-facing surface 86 of the second main support 50.

Furthermore, in the illustrated embodiment, a portion of the inner surface 132 of the first rib 90 is substantially aligned with the inner surface 124 of the first main support 44, and a portion of the inner surface 136 of the second rib 92 is substantially aligned with the inner surface 128 of the second main support 50. Accordingly, the ribs collectively form a shape (e.g., bending stress, hoop stress, etc.) that directs the stress toward the lateral center of the cross-beam/support, thereby substantially reducing the stress within the main supports. As a result, the maximum stress within the quick coupler may be substantially reduced. While a portion of the inner surface of each rib is substantially aligned with the inner surface of the respective main support in the illustrated embodiment, in other embodiments, at least one rib may be shaped such that no portion of the inner surface of the rib is substantially aligned with the inner surface of the respective main support. As used herein with regard to surfaces, “inward” refers to a direction toward a geometric center (e.g., centroid) of the quick coupler 28 along a plane formed by the lateral axis 48 and the vertical axis 60. In addition, as used herein with regard to surfaces, the outer surface and the inner surface cross the plane formed by the lateral axis 48 and the vertical axis 60, and the inner surface is positioned inward of the outer surface relative to the geometric center (e.g., centroid) of the quick coupler 28 along the plane formed by the lateral axis 48 and the vertical axis 60.

While a single rib extends along the implement-facing surface of the first main support and along the implement-facing surface of the cross-beam in the illustrated embodiment, in other embodiments, multiple ribs having any suitable shape(s) may extend along the implement-facing surface of the first main support and along the implement-facing surface of the cross-beam. In addition, while a single rib extends along the implement-facing surface of the second main support and along the implement-facing surface of the cross-beam in the illustrated embodiment, in other embodiments, multiple ribs having any suitable shape(s) may extend along the implement-facing surface of the second main support and along the implement-facing surface of the cross-beam. Furthermore, in certain embodiments, one or more branches may extend outwardly from at least one rib. In such embodiments, each branch may have any suitable shape, and each branch may extend from any suitable portion of the rib. In addition, the quick coupler may include at least one rib that extends only along the implement-facing surface of the first main support, at least one rib that extends only along the implement-facing surface of the second main support, at least one rib that extends only along the implement-facing surface of the cross-beam, or a combination thereof.

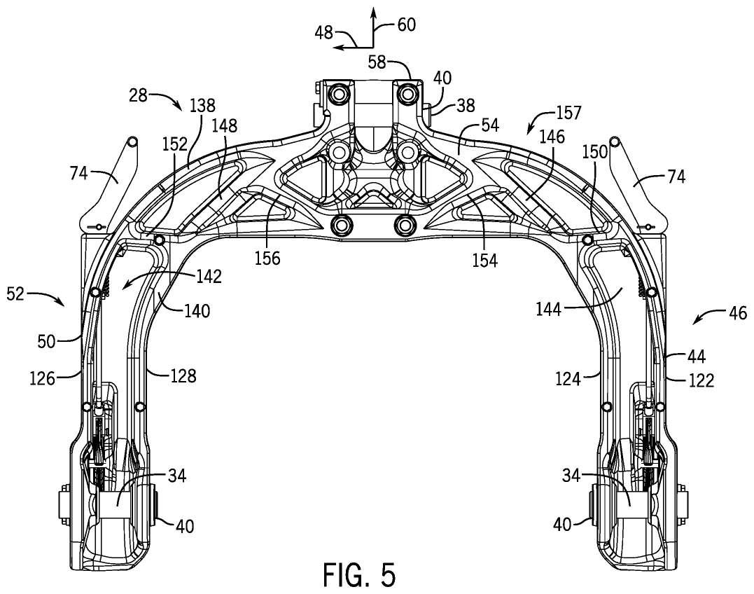

FIG. 5 is a rear view of the quick coupler 28 of FIG. 2. In the illustrated embodiment, the quick coupler 28 includes an outer shell 138 and an inner shell 140. The inner shell 140 is spaced apart from the outer shell 138 to form a hollow portion 142 between the outer shell 138 and the inner shell 140. As illustrated, the outer surface 122 of the first main support 44 and the outer surface 126 of the second main support 50 are formed by the outer shell 138. In addition, the inner surface 124 of the first main support 44 and the inner surface 128 of the second main support 50 are formed by the inner shell 140. The quick coupler 28 also includes a connecting member 144 extending between the inner shell 140 and the outer shell 138. The connecting member forms an implement-facing surface of the quick coupler 28 (e.g., including the implement-facing surface of the first main support 44, the implement-facing surface of the second main support 50, and the implement-facing surface of the cross-beam 54). In addition, the outer shell, the inner shell, and the connecting member form the first main support 44, the second main support 50, and the cross-beam 54.

In the illustrated embodiment, the quick coupler 28 includes a first cross-member 146 extending from the outer shell 138 to the inner shell 140 within the hollow portion 142, and the quick coupler 28 includes a second cross-member 148 extending from the outer shell 138 to the inner shell 140 within the hollow portion 142. Each cross-member is positioned on a vehicle side of the connecting member 144 (e.g., a side that faces the vehicle while the quick coupler 28 is coupled to the three-point hitch of the vehicle). In certain embodiments, the first cross-member 146 and the second cross-member 148 are configured to reduce compression of the quick coupler (e.g., a reduction in the distance between the outer shell and the inner shell).

In addition, in the illustrated embodiment, the quick coupler 28 includes a third cross-member 150 and a fourth cross-member 152. Each of the third and fourth cross-members extends from the outer shell 138 to the inner shell 140 within the hollow portion 142, and each of the third and fourth cross-members is positioned on the vehicle side of the connecting member 144. In certain embodiments, the third cross-member 150 and the fourth cross-member 152 are configured to reduce compression of the quick coupler (e.g., a reduction in the distance between the outer shell and the inner shell). Furthermore, in the illustrated embodiment, the quick coupler 28 includes a fifth cross-member 154 and a sixth cross-member 156. As illustrated, the fifth cross-member 154 extends from the first cross-member 146 to the inner shell 140, and the sixth cross-member 156 extends from the second cross-member 148 to the inner shell 140. In addition, each of the fifth and sixth cross-members is positioned on the vehicle side of the connecting member 144. In certain embodiments, the fifth and sixth cross-members are configured to reduce expansion of the quick coupler (e.g., an increase in the distance between the outer shell and the inner shell). While the quick coupler has six cross-members in the illustrated embodiment, in other embodiments, the quick coupler may include more or fewer cross-members (e.g., 0, 1, 2, 3, 4, 5, 7, 8, 9, 10, or more). Furthermore, the cross-members may be arranged in any suitable configuration within the hollow portion of the quick coupler.

As discussed in detail below, a portion of the first rib is aligned with the first cross-member 146, and a portion of the second rib is aligned with the second cross-member 148. As a result, two substantially thick elements may be formed within the quick coupler. The substantially thick elements may enhance the flow of stress toward the lateral center of the cross-beam/support (e.g., as compared to a configuration in which no portion of each rib is aligned with a respective cross-member), thereby further reducing stress within the main supports. Accordingly, the maximum stress within the quick coupler may be further reduced. While a portion of each rib is aligned with a respective cross-member in the illustrated embodiment, in other embodiments, no portion of at least one rib may be aligned with a respective cross-member.

Furthermore, in the illustrated embodiment, at least a portion of the outer surface of the first rib is positioned inward from an outer surface 157 of the outer shell 138 (e.g., which includes the outer surface 122 of the first main support 44 and the outer surface 126 of the second main support 50). In addition, at least a portion of the outer surface of the second rib is positioned inward from the outer surface 157 of the outer shell 138. For example, in certain embodiments, an entirety of the outer surface of the first rib is positioned inward from the outer surface of the outer shell, and an entirety of the outer surface of the second rib is positioned inward from the outer surface of the outer shell. Positioning at least a portion of the outer surface of each rib inward from the outer surface of the outer shell establishes ribs that direct stress (e.g., bending stress, hoop stress, etc.) toward the lateral center of the cross-beam/support, thereby substantially reducing the stress within the main supports. As a result, the maximum stress within the quick coupler may be substantially reduced.

As previously discussed, a portion of the quick coupler 28 (e.g., including the first main support 44, the first lower hook, the second main support 50, the second lower hook, the cross-beam 54, the first rib, and the second rib) may be formed via a casting process. In such embodiments, the portion of the quick coupler 28 may include the outer shell 138, the inner shell 140, the connecting member 144, and the cross-members. Accordingly, a substantial portion of the quick coupler (e.g., including the first main support 44, the first lower hook, the second main support 50, the second lower hook, the cross-beam 54, the first rib, the second rib, the outer shell 138, the inner shell 140, the connecting member 144, and the cross-members) may be formed as a single cast element, thereby reducing the manufacturing cost of the quick coupler (e.g., as compared to a quick coupler having a substantial portion formed by a machining process). Furthermore, as previously discussed, a portion of the quick coupler 28 (e.g., including the first main support 44, the first lower hook, the second main support 50, the second lower hook, the cross-beam 54, the first rib, and the second rib) may be formed via an additive manufacturing process (e.g., three-dimensional printing, etc.) or a reductive manufacturing process (e.g., machining, etc.). In such embodiments, the portion of the quick coupler 28 may include the outer shell 138, the inner shell 140, the connecting member 144, and the cross-members. Accordingly, a substantial portion of the quick coupler (e.g., including the first main support 44, the first lower hook, the second main support 50, the second lower hook, the cross-beam 54, the first rib, the second rib, the outer shell 138, the inner shell 140, the connecting member 144, and the cross-members) may be formed as a single additively manufactured/reductively manufactured element. In addition, as previously discussed, in certain embodiments, the quick coupler may be formed by any combination of a casting process, an additive manufacturing process, a reductive manufacturing process, a coupling process, and other suitable process(es).

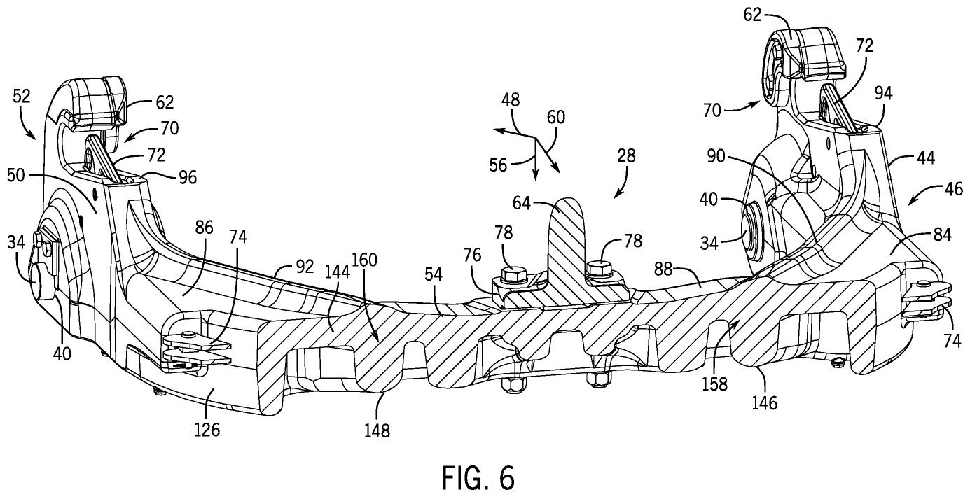

FIG. 6 is a cross-sectional view of the quick coupler 28 of FIG. 2. As illustrated, a portion of the first rib 90 is aligned with the first cross-member 146, thereby forming a first substantially thick element 158 within the quick coupler 28. In addition, a portion of the second rib 92 is aligned with the second cross-member 148, thereby forming a second substantially thick element 160 within the quick coupler 28. As used herein with regard to alignment of the portion of the rib with the respective cross-member, “align” refers to an overlap of the rib and the cross-member within a plane formed by the lateral axis 48 and the vertical axis 60 over a substantial portion of a length of the cross-member (e.g., at least 50 percent of the length of the cross-member, at least 60 percent of the length of the cross-member, at least 70 percent of the length of the cross-member, at least 80 percent of the length of the cross-member, at least 90 percent of the length of the cross-member, etc.). The substantially thick elements may enhance the flow of stress (e.g., bending stress, hoop stress, etc.) toward the lateral center of the cross-beam/support (e.g., as compared to a configuration in which no portion of each rib is aligned with a respective cross-member), thereby further reducing stress within the main supports. Accordingly, the maximum stress within the quick coupler may be further reduced. In addition, the substantially thick elements may increase the stiffness (e.g., resistance to bending) of the quick coupler (e.g., along the vertical axis).

While a portion of each rib is aligned with a respective cross-member in the illustrated embodiment, in other embodiments, no portion of at least one rib may be aligned with a respective cross-member. Furthermore, in certain embodiments, the quick coupler may include an arrangement of ribs on the implement side of the connecting member that substantially matches the arrangement of cross-members on the vehicle side of the connecting member. For example, each rib may be substantially aligned with a respective cross-member. In addition, in certain embodiments, the quick coupler may include any other suitable arrangement of ribs (e.g., in which at least a portion of at least one rib substantially aligns with a respective cross-member). For example, in certain embodiments, multiple ribs may branch out from at least one end of at least one of the first rib or the second rib.

While only certain features have been illustrated and described herein, many modifications and changes will occur to those skilled in the art. It is, therefore, to be understood that the appended claims are intended to cover all such modifications and changes as fall within the true spirit of the disclosure.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ”, it is intended that such elements are to be interpreted under 35 U.S.C. 112(f). However, for any claims containing elements designated in any other manner, it is intended that such elements are not to be interpreted under 35 U.S.C. 112(f).

1. A quick coupler for a three-point hitch, comprising:
a first main support having an implement-facing surface;
a first lower hook extending from the first main support;
a second main support having an implement-facing surface;
a second lower hook extending from the second main support;
a cross-beam extending between the first main support and the second main support, wherein the cross-beam has an implement-facing surface, and the cross-beam is configured to support an anti-rotation hook;
a first rib extending along the implement-facing surface of the first main support and along the implement-facing surface of the cross-beam, wherein a portion of an outer surface of the first rib is positioned inward from an outer surface of the first main support along the implement-facing surface of the first main support; and
a second rib extending along the implement-facing surface of the second main support and along the implement-facing surface of the cross-beam, wherein a portion of an outer surface of the second rib is positioned inward from an outer surface of the second main support along the implement-facing surface of the second main support.

2. The quick coupler of claim 1, wherein the first main support, the second main support, the cross-beam, the first rib, and the second rib are formed as a single cast element.

3. The quick coupler of claim 1, wherein a portion of an inner surface of the first rib is substantially aligned with an inner surface of the first main support, and a portion of an inner surface of the second rib is substantially aligned with an inner surface of the second main support.

4. The quick coupler of claim 1, wherein the first rib has a tapered section extending along the implement-facing surface of the cross-beam, a height of the first rib decreases within the tapered section of the first rib, the second rib has a tapered section extending along the implement-facing surface of the cross-beam, and a height of the second rib decreases within the tapered section of the second rib.

5. The quick coupler of claim 1, wherein the first rib has a first substantially straight portion, a second substantially straight portion, and a curved portion positioned between the first and second substantially straight portions of the first rib; and
wherein the second rib has a first substantially straight portion, a second substantially straight portion, and a curved portion positioned between the first and second substantially straight portions of the second rib.

6. The quick coupler of claim 1, wherein the first rib is filleted at a first interface between the first rib and the implement-facing surface of the first main support, the first rib is filleted at a second interface between the first rib and the implement-facing surface of the cross-beam, the second rib is filleted at a third interface between the second rib and the implement-facing surface of the second main support, and the second rib is filleted at a fourth interface between the second rib and the implement-facing surface of the cross-beam.

7. The quick coupler of claim 1, wherein the first rib is symmetrical with the second rib about a vertical axis of the quick coupler.

8. A quick coupler for a three-point hitch, comprising:
a first main support having an implement-facing surface and a first locking plate support, wherein the first locking plate support is configured to support a first locking plate;
a first lower hook extending from the first main support, wherein the first lower hook and the first locking plate are configured to capture a first lower hitch pin of an implement;
a second main support having an implement-facing surface and a second locking plate support, wherein the second locking plate support is configured to support a second locking plate;
a second lower hook extending from the first main support, wherein the second lower hook and the second locking plate are configured to capture a second lower hitch pin of the implement;
a cross-beam extending between the first main support and the second main support, wherein the cross-beam has an implement-facing surface, and the cross-beam is configured to support an anti-rotation hook;
a first rib extending from the first locking plate support to the cross-beam, along the implement-facing surface of the first main support, and along the implement-facing surface of the cross-beam; and
a second rib extending from the second locking plate support to the cross-beam, along the implement-facing surface of the second main support, and along the implement-facing surface of the cross-beam.

9. The quick coupler of claim 8, wherein the first main support, the second main support, the cross-beam, the first rib, and the second rib are formed as a single cast element.

10. The quick coupler of claim 8, wherein a portion of an outer surface of the first rib is positioned inward from an outer surface of the first main support along the implement-facing surface of the first main support, and a portion of an outer surface of the second rib is positioned inward from an outer surface of the second main support along the implement-facing surface of the second main support.

11. The quick coupler of claim 8, wherein the first rib has a first substantially straight portion, a second substantially straight portion, and a curved portion positioned between the first and second substantially straight portions of the first rib; and
wherein the second rib has a first substantially straight portion, a second substantially straight portion, and a curved portion positioned between the first and second substantially straight portions of the second rib.

12. The quick coupler of claim 8, wherein a portion of an inner surface of the first rib is substantially aligned with an inner surface of the first main support, and a portion of an inner surface of the second rib is substantially aligned with an inner surface of the second main support.

13. The quick coupler of claim 8, wherein the first rib has a tapered section extending along the implement-facing surface of the cross-beam, a height of the first rib decreases within the tapered section of the first rib, the second rib has a tapered section extending along the implement-facing surface of the cross-beam, and a height of the second rib decreases within the tapered section of the second rib.

14. The quick coupler of claim 8, wherein the first rib is symmetrical with the second rib about a vertical axis of the quick coupler.

15. A quick coupler for a three-point hitch, comprising:
an outer shell;
an inner shell spaced apart from the outer shell to form a hollow portion between the outer shell and the inner shell;
a connecting member extending between the inner shell and the outer shell, wherein the connecting member forms an implement-facing surface of the quick coupler, and the outer shell, the inner shell, and the connecting member form a first main support, a second main support, and a cross-beam extending between the first main support and the second main support;
a first rib extending along the implement-facing surface at the first main support and at the cross-beam, wherein at least a portion of an outer surface of the first rib is positioned inward from an outer surface of the outer shell; and
a second rib extending along the implement-facing surface at the second main support and at the cross-beam, wherein at least a portion of an outer surface of the second rib is positioned inward from an outer surface of the outer shell.

16. The quick coupler of claim 15, comprising:
a first cross-member extending from the outer shell to the inner shell within the hollow portion, wherein the first cross-member is positioned on a vehicle side of the connecting member; and
a second cross-member extending from the outer shell to the inner shell within the hollow portion, wherein the second cross-member is positioned on the vehicle side of the connecting member.

17. The quick coupler of claim 16, wherein a portion of the first rib is aligned with the first cross-member, and a portion of the second rib is aligned with the second cross-member.

18. The quick coupler of claim 15, wherein the outer shell, the inner shell, the connecting member, the first rib, and the second rib are formed as a single cast element.

19. The quick coupler of claim 15, wherein the first rib is symmetrical with the second rib about a vertical axis of the quick coupler.

20. The quick coupler of claim 15, wherein the first rib has a tapered section extending along the implement-facing surface at the cross-beam, a height of the first rib decreases within the tapered section of the first rib, the second rib has a tapered section extending along the implement-facing surface at the cross-beam, and a height of the second rib decreases within the tapered section of the second rib.
